(19) United States
(12) Patent Application Publication
(10) Pub. No.: US 2007/0119665 A1
(43) Pub. Date: May 31, 2007

(54) Outer pad abutment design for frame type calipers

(76) Inventors: Manuel Barbosa, Novi, MI (US); Sean C. Barrett, Farmington Hills, MI (US); Philip N. Jedele, Ypsilanti, MI (US)

Correspondence Address: HARNESS, DICKEY & PIERCE, P.L.C., P.O. BOX 828, BLOOMFIELD HILLS, MI, 48303, US

(21) Appl. No.: 11/288,038

(22) Filed: Nov. 28, 2005

(51) Int. Cl. F16D 65/14

(52) U.S. Cl. 188/73.45; 188/73.47

(57) ABSTRACT

A brake assembly including a caliper body that clamps brake pads against a rotor. The brake includes a support bracket defining a planar portion, a bridging portion and a pair of rails. The bridging portion extends in a generally perpendicular direction from the planar portion. The pair of rails extends from the bridging portion. Each of the rails has an inside face, an outside face, a top face, a bottom face and an outboard face. The inside face, the outside face, the top face and the bottom face are aligned in generally a perpendicular direction relative to the planar portion. A first dimension defining a length between the inside face and the outside face near the top face is less than a second dimension defining a length between the inside face and the outside near the bottom face.

### CROSS-REFERENCE TO RELATED APPLICATIONS

This application relates to U.S. patent application Ser. No. ______ filed on ______ titled Support Bracket For An Internally Abutted Brake Pad And A Hanging Brake Pad, Attorney Docket No. 2448-000027. The above disclosed application is hereby incorporated by reference as if fully set forth herein.

### FIELD

The present teachings relate to a support bracket configured to receive both a hanging brake pad and an internally abutted brake pad and more specifically to an outside abutment brake pad design and method for same.

### BACKGROUND

In one example and with reference to FIG. 1, a caliper assembly 1 may have a support bracket 2, which may be configured to receive a pair of internally abutted brake pads 3. The support bracket 2 having the pair of internally abutted brake pads 3 tends to deflect relatively less under braking loads than a support bracket having a pair of rails and the associated hanging brake pads. The support bracket 2 may include an outer beam tension member 4, to reduce the deflection under the braking load. The support brackets 2 configured to receive the pair of internally abutted brake pads 3 are, however, relatively larger and heavier than the support bracket with the pair of rails and associated hanging pads.

Typically, the support bracket with a pair of hanging rails has a bridge portion that extends over the rotor. The bridge portion may require further machining (e.g., milling, cutting, etc.) In addition, a finger may be machined into the rails that may require multi-step process to form the relatively small structure. Moreover, the center of gravity of the friction material on the outer hanging pad to be misaligned with respect to a centerline of a piston in the caliper assembly.

### SUMMARY

The present teachings generally include a brake assembly including a caliper body that clamps brake pads against a rotor. The brake assembly includes a support bracket defining a planar portion, a bridging portion and a pair of rails. The bridging portion extends in a generally perpendicular direction from the planar portion. The pair of rails extends from the bridging portion. Each of the rails has an inside face, an outside face, a top face, a bottom face and an outboard face. The inside face, the outside face, the top face and the bottom face are aligned in generally a perpendicular direction relative to the planar portion. A first dimension defining a length between the inside face and the outside face near the top face is less than a second dimension defining a length between the inside face and the outside near the bottom face.

Further areas of applicability of the present teachings will become apparent from the detailed description and the claims provided hereinafter. It should be understood that the specific examples in the detailed description, while indicating the various embodiments of the teachings, are intended for purposes of illustration only and are not intended to limit the scope of the present teachings.

### BRIEF DESCRIPTION OF THE DRAWINGS

The various embodiments of the present teachings will become more fully understood from the detailed description, the appended claims, and the accompanying drawings, wherein:

FIG. 1 is a prior art perspective view of a brake caliper assembly including a support bracket configured to internally abut a pair of brake pads and having an outer beam tension member;

FIGS. 2 and 3 are perspective views of a disc brake assembly showing a rotor received by a support bracket having an abutted brake pad and a hanging brake pad constructed in accordance with the present teachings;

FIG. 4 is a bottom view of the disc brake assembly of FIGS. 2 and 3;

FIG. 5 is a cross-sectional view of the disc brake assembly of FIG. 4 showing the caliper body in an unclamped or open position in accordance with the present teachings;

FIG. 6 is similar to FIG. 5 and shows the caliper in a clamped position;

FIG. 7A is a perspective view of the outboard side of the support bracket of FIGS. 2 and 3 in accordance with the present teachings;

FIG. 7B is a perspective view of the inboard side of the support bracket of FIG. 7A;

FIG. 8A is similar to FIG. 7A and shows a hanging brake pad connected to the support bracket in accordance with the present teachings;

FIG. 8B is similar to FIG. 7B and shows the internally abutted brake pad held within the support bracket;

FIG. 9A is a perspective view of the internally abutted brake pad of FIG. 8B;

FIG. 9B is a perspective view of the hanging pad of FIG. 8A;

FIG. 10 is a perspective view of the hanging brake pad and support bracket of FIG. 8A showing removal of the hanging brake pad without the need for removal of the support bracket or the rotor and in addition removal of the rotor without the need to remove the support bracket from a portion of the vehicle in accordance with the present teachings;

FIGS. 11 and 12 are perspective views of an alternative embodiment showing a portion of an inside face of the hanging rail inclined at about forty-five degrees and brake pad with a rail channel having a complementary shape in accordance with the present teachings;

FIGS. 13 and 14 are perspective views of an alternative embodiment showing a rounded portion of an inside face of the hanging rail and brake pad with a rail channel having a complementary shape in accordance with the present teachings;

FIGS. 15 and 16 are perspective views of an alternative embodiment showing a portion of an outside face of the hanging rail inclined at about forty-five degrees and brake pad with rail channel having a complementary shape in accordance with the present teachings; and

FIG. 17 is a perspective view of an exemplary cutting tool forming the hanging rails of the support bracket in accordance with the present teachings.

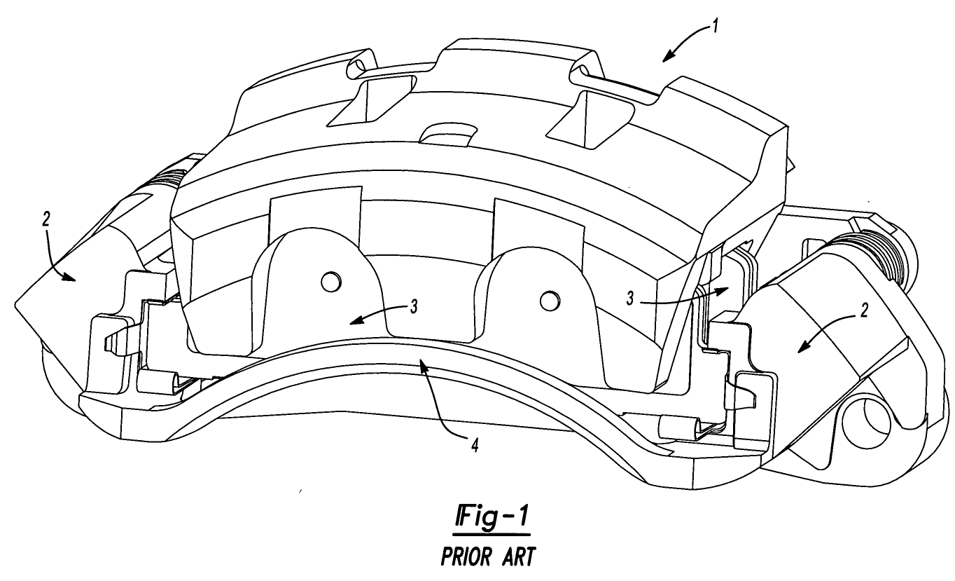

### DETAILED DESCRIPTION OF THE VARIOUS EMBODIMENTS

The following description of the various embodiments is merely exemplary in nature and is in no way intended to limit the teachings, their application, or uses.

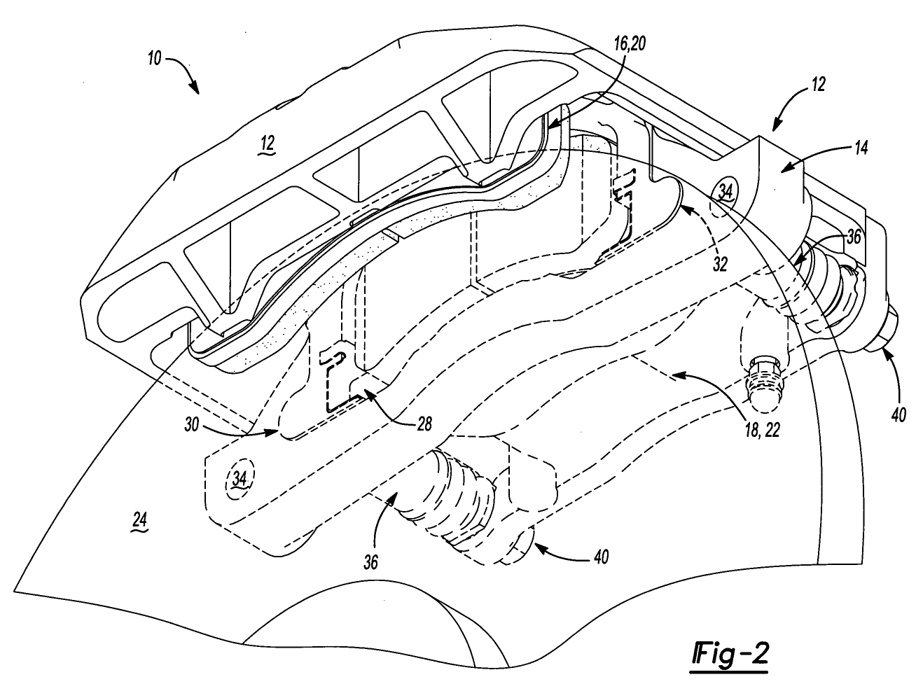

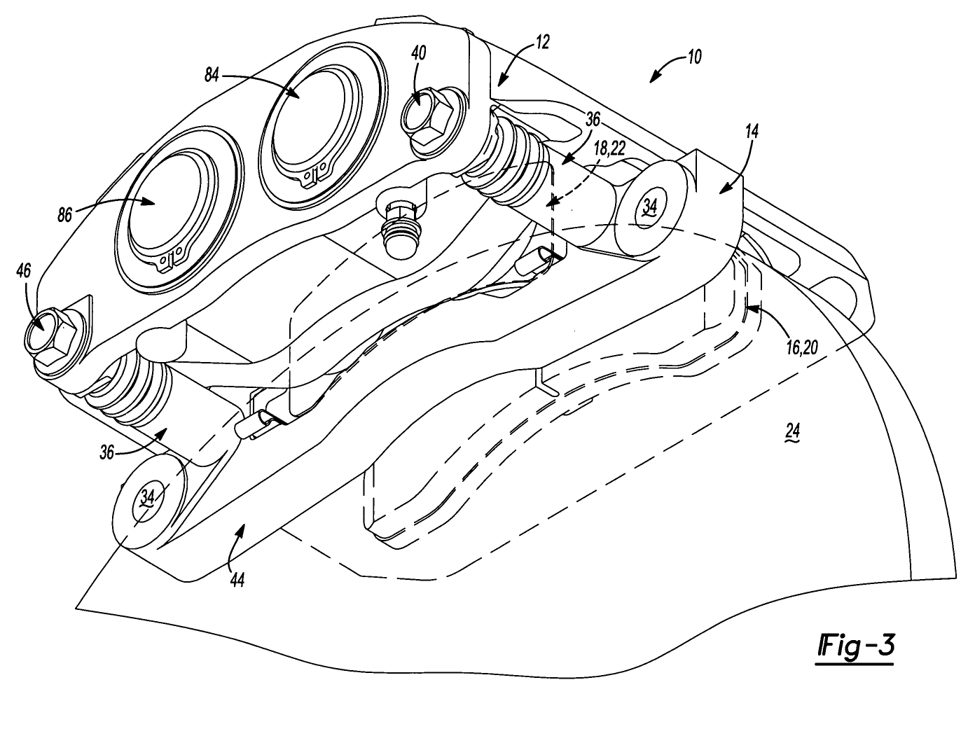

The present teachings generally include a disc brake system 10. While the present teachings are generally described and illustrated with reference to a vehicle and an exemplary associated suspension and drive train, the present teachings remain applicable in various applications to aid in slowing of rotating motion. With reference to FIGS. 2 and 3, the disc brake assembly 10 includes a caliper body 12, a support bracket 14, an outboard brake pad 16 and an inboard brake pad 18. In one example, the support bracket 14 is configured to receive a hanging brake pad 20 and an internally abutted brake pad 22. In this regard, the outboard brake pad 16 may define the hanging brake pad 20, while the inboard brake pad 18 may define the internally abutted brake pad 22. In other examples, the position of the brake pads may be reversed. The caliper body 12 may connect to the support bracket 14 and be moveable relative thereto when clamping the brake pads 16, 18 against a rotor 24 to slow the motion of a vehicle (not shown).

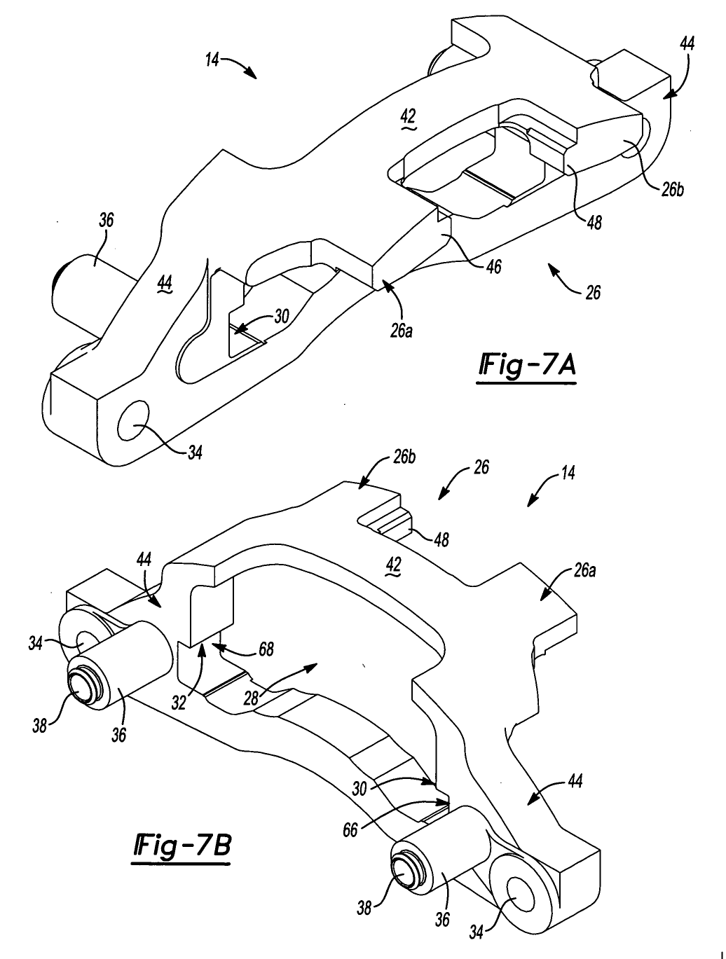

The support bracket 14 may define hanging rails 26 (FIGS. 7A and 7B) and an aperture 28. The aperture 28 may serve as an internal abutment portion for the internally abutted brake pad 22. The hanging rails 26 may include a front rail 26a and rear rail 26b from which the hanging brake pad 20 may be coupled. With regard to abutting the brake pad 22, the aperture 28 may define a front abutment portion 30 and a rear abutment portion 32 that receive (i.e. abut) the internally abutted brake pad 22.

The support bracket 14 may also define two mounting holes 34. The mounting holes 34 may facilitate coupling the support bracket 14 locations on the vehicle (not shown) using various suitable methods. The support bracket 14 may further define two mounting bosses 36 in which an aperture 38 (FIG. 7B) is formed. A fastener 40 may couple the caliper body 12 to the support bracket 14 via the aperture 38 on the mounting boss 36 and further allow the caliper body 12 to move relative to the support bracket 14 when clamping against the rotor 24. In this regard, the support bracket 14 remains fixed with the vehicle and the caliper body 12 moves relative to the rotor 24.

In one example and with reference to FIGS. 7A and 7B, the support bracket 14 is a single piece of material, i.e., monolithic. For example, the support bracket 14 may be made from a single casting. The support bracket 14 may define a bridging portion 42 that extends over the rotor 24. The bridging portion 42 may extend in a generally perpendicular direction from a generally planar portion 44 of the support bracket 14. The hanging rails 26 may extend from the bridging portion 42. In this regard, the planar portion 44 may define the aperture 28 that receives (i.e., abuts) the internally abutted brake pad 22, while the hanging rails 26 can hold the hanging brake pad 20.

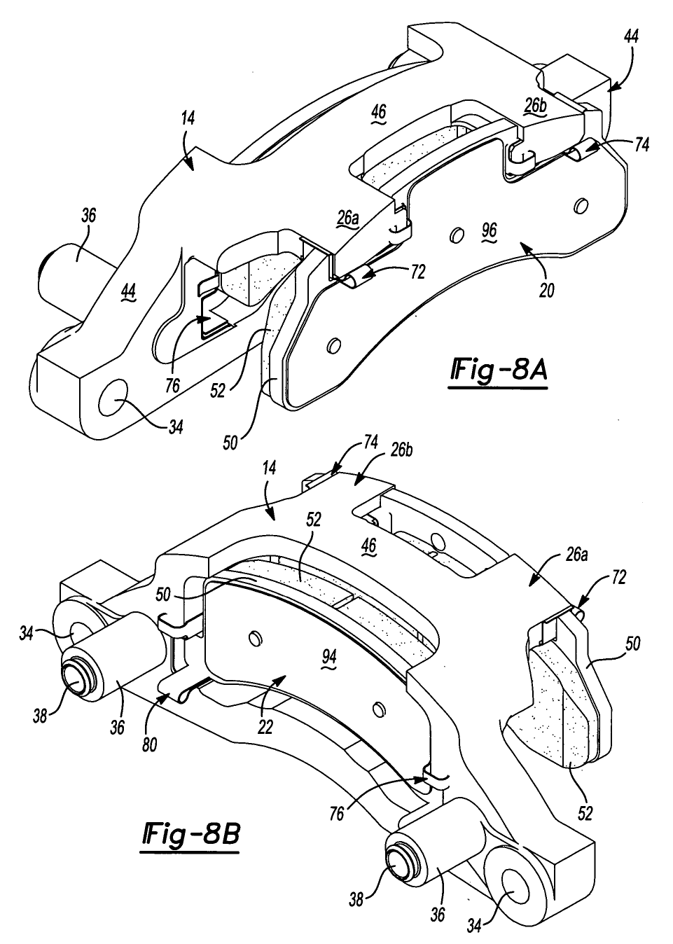

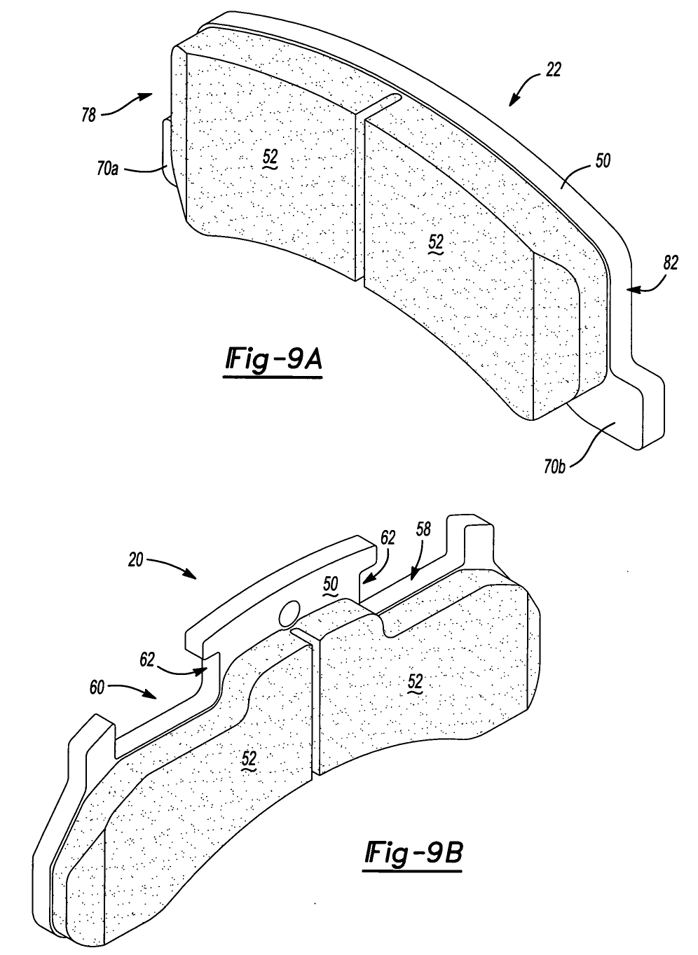

With regard to the hanging rails 26, the front rail 26a includes a protrusion 46 that may face the rear rail 26b. The rear rail 26b includes a protrusion 48 that may face the front rail 26a. With reference to FIGS. 9A and 9B, the brake pads 20, 22 include a backing member 50 and a friction material 52. With reference to FIG. 8B and FIG. 9B, the backing member 50 defines a front rail channel 58 and a rear rail channel 60. The rail channels 58, 60 further define respective grooves 62. In one example, the grooves 62 may be formed on inside walls of the rail channels 58, 60. When the hanging brake pad 20 is received by (and hangs from) the rails 26, the protrusions 46, 48 are received by the grooves 62 and thus hold the brake pad 20 to the rails 26. When the caliper body 12 clamps the brake pads 20, 22 against the rotor 24, the hanging brake pad 20 travels along the rails 26, thus contacting the rotor 24 with the friction material 52 to slow the vehicle.

With reference to FIGS. 7B and 8B, the support bracket 14 defines the aperture 28 that receives and abuts the internally abutted brake pad 22. The front abutment portion 30 may define a front channel 66 and the rear abutment portion 32 may define a rear channel 68. The backing member 50 of the internally abutted brake pad 22 may define a pair of flanges 70 (FIG. 9A) that is received in the front channel 66 and the rear channel 68, respectively. More specifically, a front flange 70a (FIG. 9A) may abut the front channel 66 formed in the front abutment portion 30 during a braking load, i.e., when the vehicle is slowed in a forward direction. A rear flange 70b (FIG. 9A) may similarly abut the rear channel 68 formed in the rear abutment portion 32 during an opposite braking load i.e., when the, vehicle is slowed in a rearward direction. It will be appreciated that the internally abutted brake pad 22 is held within the aperture 28 while no braking load is supplied.

In one example and with reference to 8A and 9B, a front rail clip 72 may be disposed between the front rail 26a and the front rail channel 58. A rear rail clip 74 may be disposed between the rear rail 26b and the rear rail channel 60. With reference to FIGS. 8B and 9A, a front abutment clip 76 may be disposed between the front abutment portion 30 and a front side 78 of the internally abutted brake pad 22. The front side 78 of the brake pad 22 may further define the aforementioned front flange 70a. A rear abutment clip 80 may be disposed between the rear abutment portion 32 and a rear side 82 of the internally abutted brake pad 22. The rear side 82 of the brake pad 22 may define the aforementioned rear flange 70b.

It may be shown that one or more of the clips 72, 74, 76, 80 may reduce the friction between the above-mentioned portions and structures of the support bracket 14 and the pads 20, 22 between which the clips 72, 74, 76, 80 are respectively disposed relative to contact therebetween without the clips 72, 74, 76, 80. Moreover, it may be shown that the clips 72, 74, 76, 80 position and provide tension between the internally abutted brake pad 22, the aperture 28, the rails 26 and rail channels 66, 68. The tension between the pads 20, 22 and the support bracket 14 may be shown to reduce noise, vibration or harshness in the disc brake assembly 10.

With reference to FIGS. 2, 3 and 4, the caliper body 12 includes a first piston 84, a second piston 86, an inboard contact surface 88 and an outboard contact surface 90. The pistons 84, 86 may be formed on (and behind) the inboard contact surface 88. The outboard contact surface 90 is about opposite to the inboard contact surface 88, i.e., on opposite sides of the rotor 24. A face 92 of each piston 84, 86 contacts the backing member 50 of the inboard brake pad 18 (illustrated as the internally abutted brake pad 22).

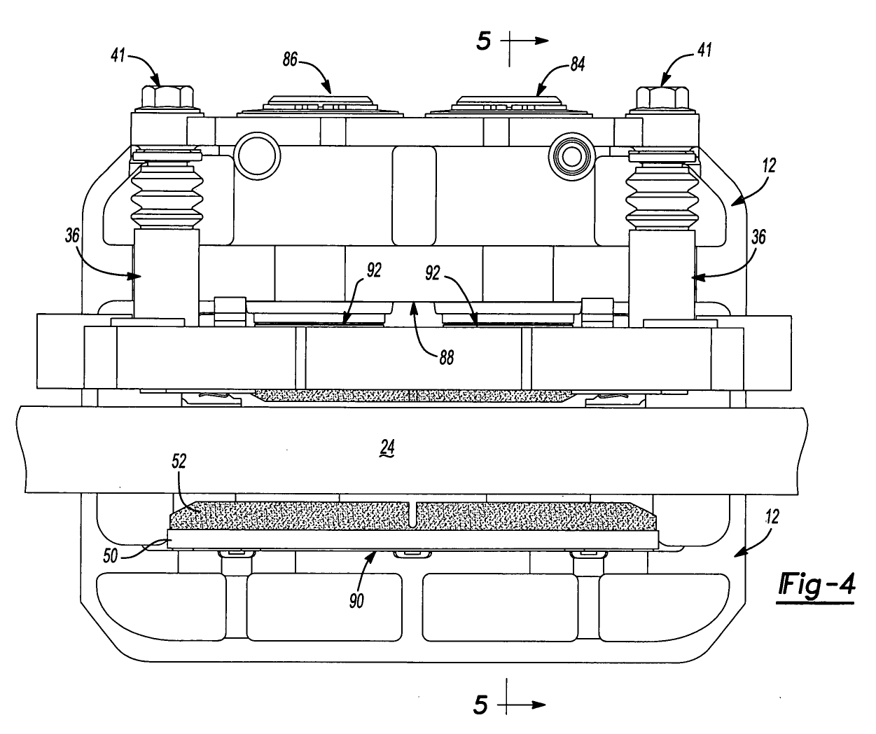

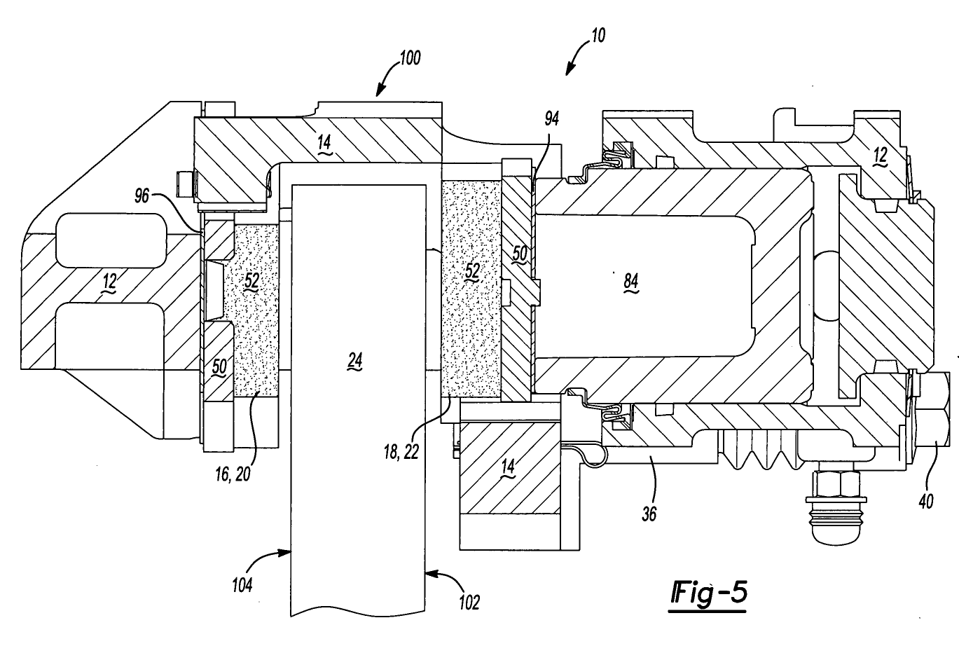

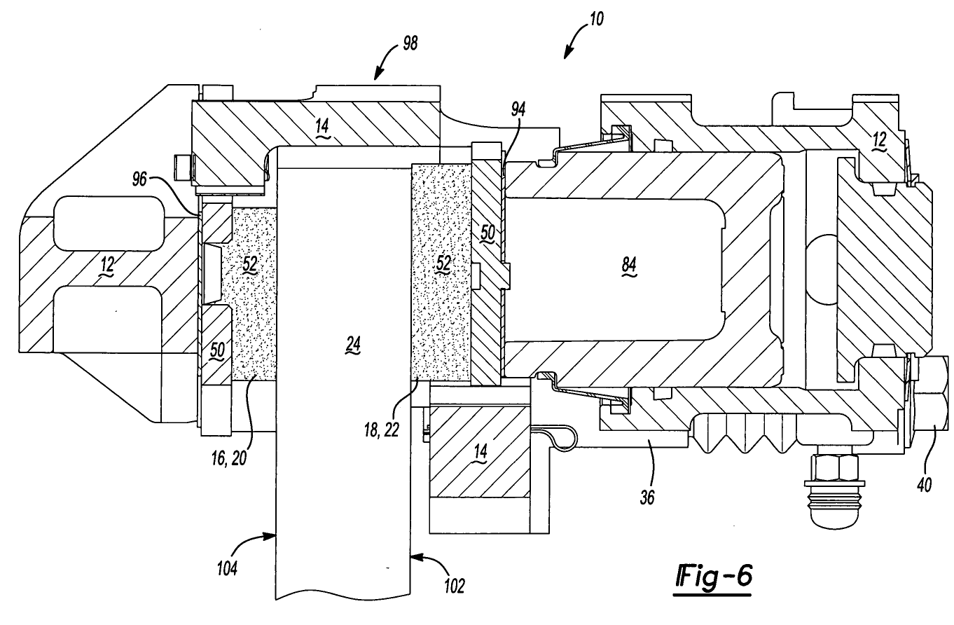

An inboard shim 94 may be placed between the inboard brake pad 18 and the faces 92 of the pistons 84, 86 respectively. It will be appreciated when the pistons 84, 86 are fully retracted (i.e., flush or recessed with the caliper body 12), the inboard shim 94 (FIGS. 5 and 6) may contact the outboard contact surface 90. The outboard contact surface 90 may abut the backing member 50 of the outboard brake pad 16 (illustrated as the hanging pad 20). An outboard shim 96 (FIGS. 5 and 6) may be placed between the outboard brake pad 16 and the outboard contact surface 90 of the caliper body 12. The caliper body 12 may also include a suitable hydraulic valve that may allow for addition, removal and/or maintenance of a hydraulic fluid within the first and second pistons 84, 86.

In operation and with reference to FIGS. 5 and 6, the pistons 84, 86 may be extended and retracted by manipulating the hydraulic fluid pressure in the caliper body 12. By increasing the hydraulic fluid pressure to the pistons 84, 86, the pistons 84, 86 extend out of the caliper body 12 and define an extended or clamping position 98. By reducing the hydraulic pressure to the pistons 84, 86, the pistons 84, 86 retreat into the caliper body 12 and define an unclamped or retracted position 100. In the clamped position 98, the faces 92 of the respective pistons 84, 86 urge the inboard brake pad 18 toward an inboard face 102 of the rotor 24. The caliper body 12 also moves relative to the support bracket 14 and the rotor 24 and therefore urges the outboard brake pad 16 toward an outboard face 104 of the rotor 24. The friction material 52 on the inboard and the outboard brake pads 16, 18 contact the faces 102, 104 of the rotor 24. The pistons 84, 86 may continue to urge the pads 16, 18 against the rotor 24, thereby clamping the rotor 24 and reducing its rotational velocity to thereby slow the vehicle. By contacting the rotor 24, the friction material 52 on the brake pads 20, 22 wear due to the heat and abrasion while engaging the rotor 24.

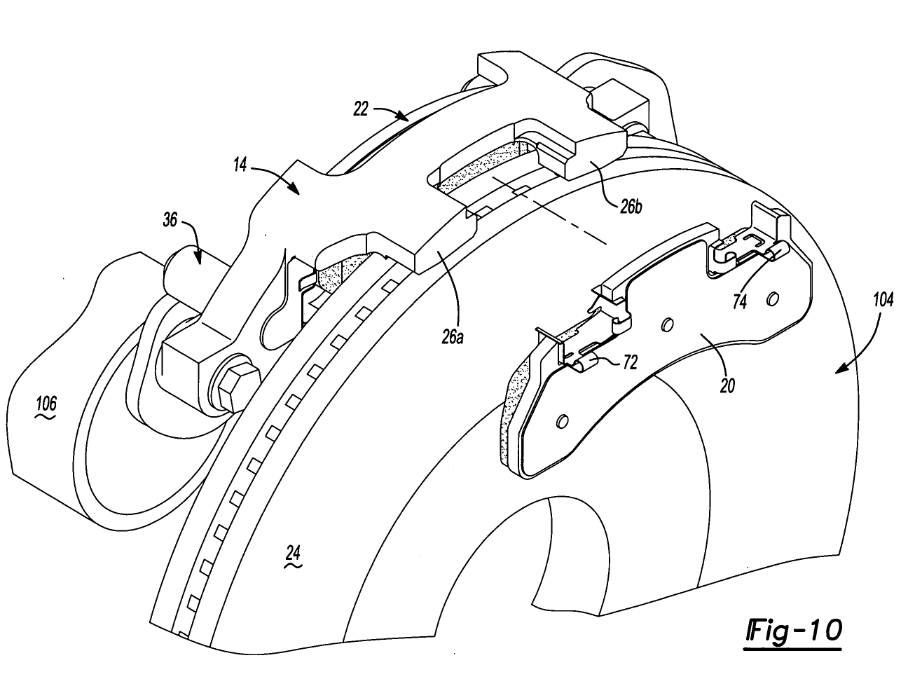

In one example and with reference to FIG. 10, the hanging brake pad 20 may be removed from the hanging rails 26 (26A and 26B) without removal of the rotor 24 or the support bracket 14 from an applicable portion (e.g. a bracket 106) of the vehicle. In a further example, the rotor 24 may be removed from an applicable portion of the vehicle (e.g., a drive shaft flange) without the need for removing the support bracket 14 from the bracket 106. More specifically, the caliper body 12 is removed from the support bracket 14 by, for example, removing the fasteners 40 from the mounting bores 36 (FIG. 3). With the caliper body 12 removed from the support bracket 14, the hanging brake pad 20 may be slid off the hanging rails 26. Additionally, the rotor 24 may be removed without the need to uncouple the support bracket 14. In this regard, the hanging rails 26 are configured so that the rotor 24 may decouple from (i.e., pulled away) the driveshaft flange. Specifically, the rotor 24 is pulled laterally away from the vehicle, e.g., along the rotor's installed axis of rotation (i.e., an axis upon which the rotor 24 spins while installed on the vehicle in a normal fashion).

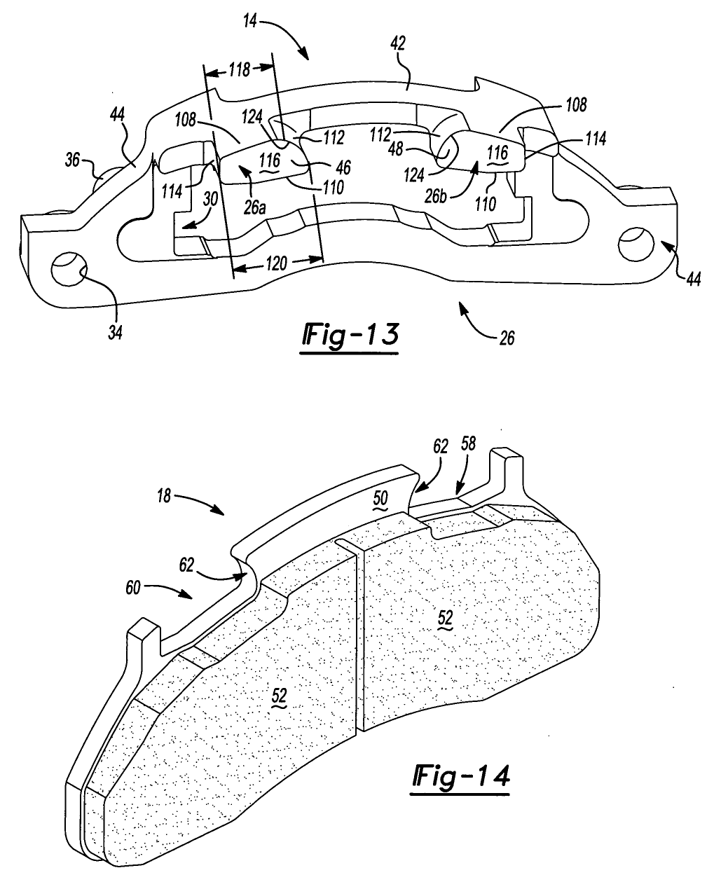

With reference to FIGS. 11, 13 and 15, the rails 26 may each have a top face 108, a bottom face 110, an inside face 112 and an outside face 114. An outboard face 116 is formed at a terminus of the hanging rail 26 and thus connects with the aforesaid top, bottom, inside and outside faces 108, 110, 112, 114. The inside face 112, the outside face 114, the top face 108 and the bottom face 110 are aligned generally perpendicular to the planar portion 44 of the support bracket 114. In one example and with reference to FIG. 13, a dimension 118 defining a first length between the inside face 112 and the outside face 114 near the top face 108 of the hanging rail 26 is less than a dimension 120 defining a second length between the inside face 112 and the outside face 114 near the bottom face 110.

In one example and with reference to FIG. 11, each of the hanging rails 26 may have at least a portion of the inside face 112 inclined about forty-five degrees (or other suitable angle) relative to the outside face 114. More specifically, a portion 112a of the inside face 112 near the top face 108 may be inclined at about a forty-five degree angle (or other suitable angle), while the remaining portion 112b of the inside face 112 near the bottom face may be straight and/or parallel to the outside face 114. In one example, the bottom face 110 may be entirely flat. In other examples, the bottom face 110 may also define two or more regions. Each region may be inclined relative to the other region thus forming, for example, an acute angle between the regions. One region 122 (i.e., a planar portion of the bottom face 110) may be inclined to abut a portion of the backing member 50 of the brake pad 18. In this regard, the force generated during braking causes the pad 18 to move toward and abut the hanging rail 26.

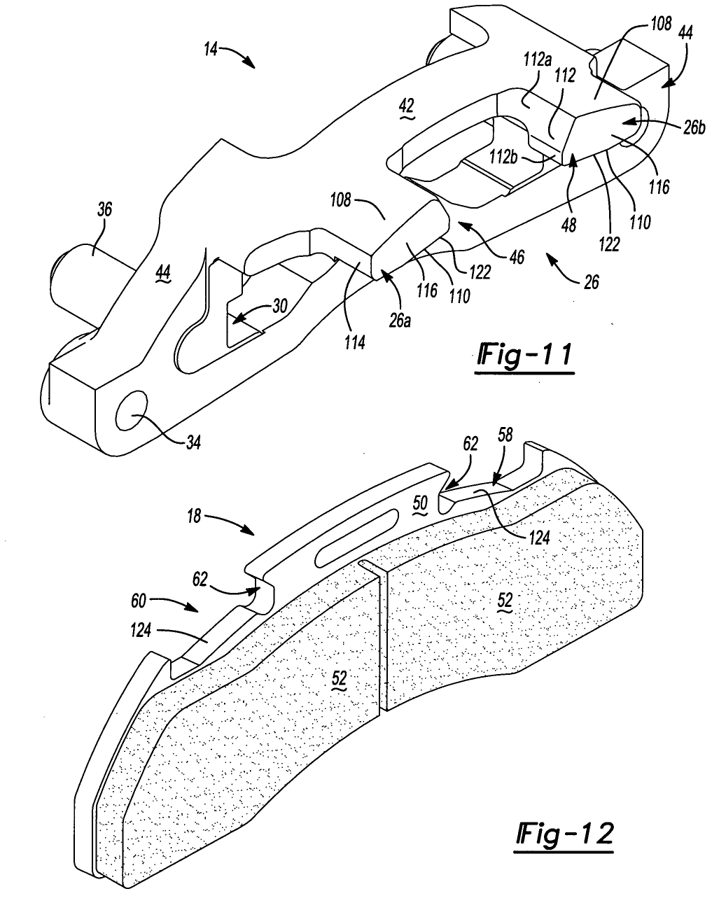

With reference to FIG. 12, the rear rail channel 60 and the front rail channel 58 may be configured to compliment the shapes of the hanging rails 26. More specifically, the grooves 62 formed in the rail channels 58, 60 may have a complimentary shape to the portion 112a of the inside face 112 that is inclined about forty-five degrees. In addition, a ramped surface 124 may be about parallel to the region 122 formed on the bottom face 110 of the hanging rail 26. The front and/or rear rail channels 58, 60 may also corners that have an over-sized radius corners to accept edges of the hanging rails 26 especially during motion of the brake pad 18 during braking.

With reference to FIG. 13, the inside face 112 of each of the hanging rails 26 may have an arcuate portion 126 that runs between the top face 108 and the bottom face 110. More specifically, the arcuate portion 126 may be formed on or along the inside face 112 and/or the top face 108 of the hanging rail 26. The bottom face 110 of the hanging rail may (or may not) be configured similar to the hanging rail 26 illustrated in FIG. 11. In the various examples, the backing member 50 (FIG. 14) may abut the hanging rail at one or more of faces 108, 110, 112, 114 depending on the braking load.

With reference to FIG. 14, the front rail channel 58 and the rear rail channel 60 may be configured to receive the hanging rails 26 as illustrated in FIG. 13. More specifically, the grooves 62 formed in the rail channels 58, 60 may have complimentary shapes to at least the rounded or arcuate portion 126 of the inside face 112.

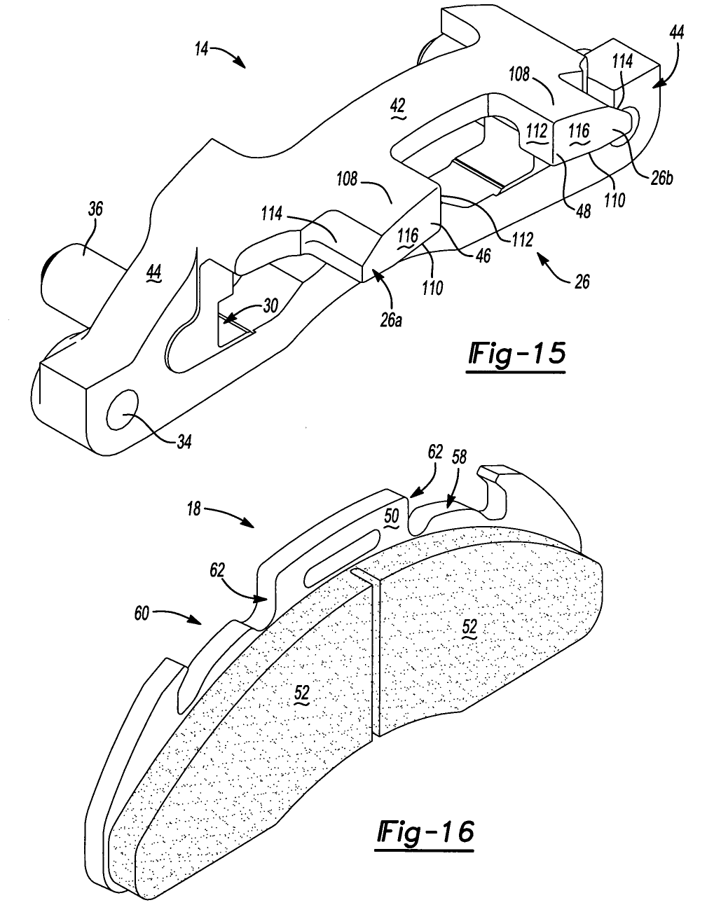

With reference to FIG. 15, the outside face 114 may include an inclined portion 114a relative to the inside face 112. The inclined portion 114a may be at an angle of about forty-five degrees such that an inclined portion 114a (e.g., upper portion) of the outside face 114 may be inclined at about forty-five degrees relative to the bottom portion 114b which is straight relative to the inside face 112. As such, the bottom portion 114b of the outside face 114 is about parallel to the inside face 112. The bottom face 110 of the hanging rail 26 may or may not include a configuration similar to the hanging rail 26 illustrated in FIG. 11.

With reference to FIG. 16, the front rail channel 58 and the rear rail channel 60 may be configured to compliment the hanging rails 26 as illustrated in FIG. 15. More specifically, the groove 62 formed in the rail channels 58, 60 may compliment the upper portion on 114b that is inclined. It will be appreciated that the front rail 26a and the rear rail 26b may be configured identically or may be configured dissimilarly. As such, the respective rail channels 58, 60 formed in backing member 50 of the hanging pad 18 may (or may not) have complimentary rail channel 58 or 60 configurations.

With reference to FIGS. 11 through 16, the faces 108-116 of the hanging rail 26 and the configuration of the rail channels 58, 60 are such that the faces 108-116 may be connected with rounded (beveled and/or chamfered) corners. Moreover, the bottom face 110 may provide sufficient clearance relative to the rotor 24 so as to permit removal of rotor 24 along its installed axis of rotation, as illustrated in FIG. 10.

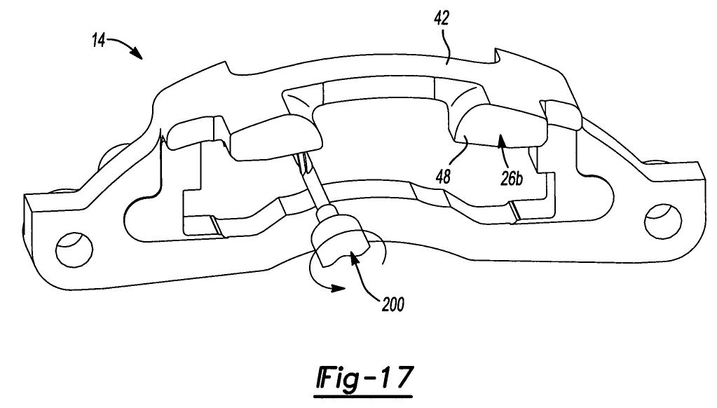

With reference to FIG. 17, a cutting tool 200 (e.g. a mill or other suitable cutting machine) can trim the hanging rail 26 in a single pass to produce the one or more rounded edges on the hanging rail 26. In one example, only the hanging rails 26 require cutting by the cutting tool 200. Specifically, the bridging portion 42 need not be cut or trimmed especially a surface 202 which is adjacent to (i.e., extends over) the rotor 24. The surface 202 may be left as-cast (i.e., no additional finish steps). It will be shown that need to only cut the hanging rails 26 and thus not cut (trim or grind) the bridging portion 42 may save time and costs.

With reference to FIGS. 11-16, it will be shown that the various aforementioned configurations of the rail channels 58, 60 may allow positioning of the friction material 52 relative to the backing member 50 such that a center of gravity of the friction material 52 is closer to a center line of the piston.

Those skilled in the art can now appreciate from the foregoing description that the broad teachings may be implemented in a variety of forms. Therefore, while the present teachings have been described in connection with the specific examples thereof, the true scope of the present teachings should not be so limited because other modifications will become apparent upon a study of the drawings, the specification, and the following claims.

What is claimed is:

1. A brake assembly including a caliper body that clamps brake pads against a rotor, the brake assembly comprising:
a support bracket defining a planar portion, a bridging portion and a pair of rails;
said bridging portion extends in a generally perpendicular direction from said planar portion; and
said pair of rails extend from said bridging portion, each of said rails having an inside face, an outside face, a top face, a bottom face and an outboard face, wherein said inside face, said outside face, said top face and said bottom face are aligned in generally a perpendicular direction relative to said planar portion and wherein a first dimension defining a length between said inside face and said outside face near said top face is less than a second dimension defining a length between said inside face and said outside near said bottom face.

2. The brake assembly of claim 1 wherein at least a portion of said outside face is inclined at about a forty-five degree angle relative to said inside face.

3. The brake assembly of claim 1 wherein at least a portion of said inside face is inclined at about a forty-five degree angle relative to said outside face.

4. The brake assembly of claim 1 wherein at least a portion of said outside face defines an arcuate portion relative to said inside face.

5. The brake assembly of claim 1 wherein at least a portion of said inside face defines an arcuate portion relative to said outside face.

6. The brake assembly of claim 1 wherein at least a portion of said inside face or said outside face interferes with one of the pads to prevent the pad from falling from the support bracket.

7. The brake assembly of claim 1 wherein said support bracket is a unitary construction.

8. The brake assembly of claim 1 wherein a first rail includes a first protrusion that extends from said first rail toward a second rail, said second rail having a second protrusion that extends toward said first rail.

9. A brake assembly having a caliper that connects to a support bracket holding a first and a second brake pad, the caliper can clamp the pads against the rotor, the support bracket comprising:
a first portion that receives the first brake pad;
a second portion that extends from said first portion; and
a rail that extends from said second portion, said rail holds the second brake pad, wherein the second brake pad is removable from said support bracket without moving the rotor from at least partially between the first and the second brake pads.

10. The brake assembly of claim 9 wherein the rotor defines an installed axis of rotation, wherein a distance between said installed axis of rotation and a bottom face of said rail permits removal of the rotor generally along said installed axis of rotation.
